(19) United States
(12) Patent Application Publication
(10) Pub. No.: US 2018/0300653 A1
(43) Pub. Date: Oct. 18, 2018

(54) Distributed Machine Learning System

(71) Applicant: Distributed Systems, Inc., San Francisco, CA (US)

(72) Inventors: Nikhil Vikram Srinivasan, San Francisco, CA (US); Alexander Simon Kern, San Francisco, CA (US)

(21) Appl. No.: 15/955,918

(22) Filed: Apr. 18, 2018

Related U.S. Application Data
(60) Provisional application No. 62/486,881, filed on Apr. 18, 2017.

(51) Int. Cl. G06N 99/00; G06F 9/48; H04L 29/08

(52) U.S. Cl. CPC G06N 99/005; H04L 67/06; G06F 9/4881

(57) ABSTRACT

A distributed machine learning system and method are disclosed. According to some implementations of this disclosure, the method includes identifying one or more available computing resources and receiving a task object that indicates a training job to perform. The method includes retrieving a container image based on the type of model architecture. The container image includes the model architecture and a filesystem. The method includes retrieving and mounting a base model to the filesystem of the container image. The method further includes retrieving and mounting a volume of training data to the filesystem of the container image to obtain a training container. In some implementations, the method further includes executing the training container on at least one of the one or more available computing resources and receiving a trained model from the container after the container completes the training job. The method further includes storing the trained model.

### CROSS REFERENCE TO RELATED APPLICATION(S)

This disclosure claims the benefit of U.S. Provisional Application No. 62/486,881, filed Apr. 18, 2017, the disclosure of which is hereby incorporated by reference in its entirety.

### TECHNICAL FIELD

This disclosure relates to a distributed machine learning system.

### BACKGROUND

Machine learning is becoming prevalent in many different scientific, commercial, and economic disciplines and a cornerstone of artificial intelligence. Machine learning is a broad field of computer science that aims to allow machines to perform a task without being explicitly being programmed to perform the exact task. Many of these tasks are centered around the training of a model using collected data from one or more sources and using that model to make a decision or prediction based on the model. In this way, a computer is able to organize and analyze volumes of data in a way that humans are unable to. Traditionally, training a model requires specific expertise on how to code the model and to structure the data. Additionally, machine learning can be a computationally expensive undertaking that many organizations do not have readily available. Furthermore, as many of the disciplines that are migrating towards the use of machine learning are not traditional computer-science related fields (e.g., scientific, automotive, medical, and financial fields), many organizations do not have the human resources to build robust machine learning systems. Thus, there is a need for a distributed machine learning system.

### SUMMARY

A method and system for operating a distributed machine learning system is disclosed. According to some implementations of this disclosure, the method includes identifying one or more available computing resources from a plurality of computing resources, the plurality of computing resources including at least one central processing unit and at least one graphical processing unit. The method further includes receiving a task object that indicates a training job to perform and a type of model architecture to perform the training job and retrieving a container image based on the type of model architecture. The container image includes the model architecture and a default filesystem. The model architecture includes one or more software libraries that define computer executable instructions that operate on a model. According to some implementations, the method includes retrieving a base model including a plurality of weights and mounting the base model to the filesystem of the container image. In some implementations, the method further includes retrieving a volume of training data. A volume of training data may define a plurality of events, each event including at least one instance of observation data and at least one instance of outcome data. The method may further include mounting the volume of training data to the filesystem of the container image to obtain a training container. In some implementations, the method further includes executing the training container on at least one of the one or more available computing resources and receiving a trained model from the container after the container completes the training job. The method further includes storing the trained model in non-transitory memory, wherein the trained model is subsequently used to generate a serving container.

The disclosure includes additional and alternative methods. This disclosure also includes apparatuses, systems, and the like which may perform some or all of the methods, additional methods, and alternative methods described herein.

The details of one or more implementations of this disclosure are set forth in the accompanying drawings and the description below. Other aspects, features, and advantages will be apparent from the description and drawings, and from the claims.

### DESCRIPTION OF DRAWINGS

FIG. 1A is a schematic illustrating an example environment of a distributed machine learning system.

FIG. 1B is a schematic illustrating an example environment of a distributed machine learning system that transmits serving containers to remote computing devices.

FIG. 2A is a schematic illustrating an example set of components of a distributed machine learning system.

FIG. 2B is a schematic illustrating an example volume of training data.

FIG. 2C is a schematic illustrating an example container image.

FIG. 2D is a schematic illustrating an example model bundle.

FIG. 3 is a schematic illustrating an example of the distributed machine learning system executing a plurality of machine learning containers.

FIG. 4 is a flow chart illustrating an example set of operations for operating a distributed machine learning system.

FIG. 5 is a flow chart illustrating an example set of operations for generating a training container.

FIG. 6 is a flow chart illustrating an example set of operations for generating a serving container.

Like reference symbols in the various drawings indicate like elements.

### DETAILED DESCRIPTION

This disclosure relates to a distributed machine learning system. A distributed machine learning system is a set of one or more computing systems that is configured to receive input from one or more external computing systems, which may each be operated by a respective human administrator, whereby the DML systems performs machine learning tasks. The machine learning tasks include the manner by which one or more machine learned models are trained (e.g., selecting a model architecture) and defining additional hyper parameters that are used by the distributed machine learning system. In some implementations, the distributed machine learning system utilizes machine learning containers (“ML containers” or “containers”) to perform training tasks and prediction tasks (which may also be referred to as “training jobs” and “prediction jobs”). A training task can refer to the process of training a machine learned model according to a particular model architecture. A prediction task can refer to the process of utilizing a machine learned model to make a prediction given an input signal and a particular model architecture. A ML container can refer to a virtual software execution environment that may be executed across one or more processing devices and configured to perform a specific machine learning task. ML containers can include training containers and/or serving containers. In some implementations, the ML containers are containers, which may be instantiated from Docker container images.

A training container may refer to a ML container that includes executable instructions that implement a model architecture and one or more volumes of training data mounted to the filesystem of the container. In this way, the training container may act as a special purpose computer that is only configured to perform the specific training task defined by the model architecture. A model architecture may include one or more software libraries and/or additional code that, when executed, cause the DML system to operate on a particular type of model pertaining to the architecture. Examples of model architectures can include, but are not limited to, decision tree learning, clustering, neural networks, deep learning neural networks, support vector machines, linear regression, logistic regression, naïve Bayes classifiers, k-nearest neighbor, k-means clustering, random forests, gradient boosting, and other suitable model architectures. The foregoing list is provided for example and does not limit the types of model architectures that may be implemented by the DML system. In some implementations, a model architecture may include machine-readable instructions that cause the container to execute a training process only or a serving process only. In other implementations, the model architecture may include the machine-readable instructions that cause the container to execute both the training process and the serving process.

The DML system generates a training container by retrieving a container image that is configured with a particular model architecture and by mounting a volume of training data to the filesystem of the container image. The DML system assigns the training container to one or more processors, where the processors can include special processors such as graphics processor units (GPUs). Once the training container begins executing on the assigned processor(s), the container is a self-contained computer and outputs a machine learned model, which may be used in a serving container to issue predictions. Furthermore, the DML system may segment a volume of training data across multiple training containers and may assign the different training containers to parallel resources, thereby enabling batch training on a large training data set. Batch training may refer to the practice of separating a training data set into multiple subsets and training multiple models with the respective subsets. The multiple models may then be merged into a single model that is used in a serving container.

A serving container may refer to a container that includes executable instructions that implement a model architecture and a machine learned model bound to the container. A serving container may be configured to receive input signals that represent events and to output a prediction based on the input signals and the machine learned model. The DML may execute the serving container. Additionally or alternatively, the DML system may be configured to transmit the serving container to a client device, whereby the client device executes the serving container.

In some implementations, the DML system includes a scheduler that assigns training and/or prediction jobs to the various hardware computing resources of the DML system. In some of these implementations, the DML system may include one or more processing devices (e.g., one or more CPUs) and one or more specialized processing devices (e.g., one or more graphics processing units). The scheduler selects allocates computing resources (e.g., one or more CPUs and/or GPUs) to requested training and/or prediction jobs based on the priority of the respective jobs and/or the minimum required resources for each respective job. The scheduler may further determine whether to parallelize a training task. If the scheduler decides a training task may be parallelized, the scheduler may segment a volume of data across multiple containers and may assign the containers to the processing resources of the DML system.

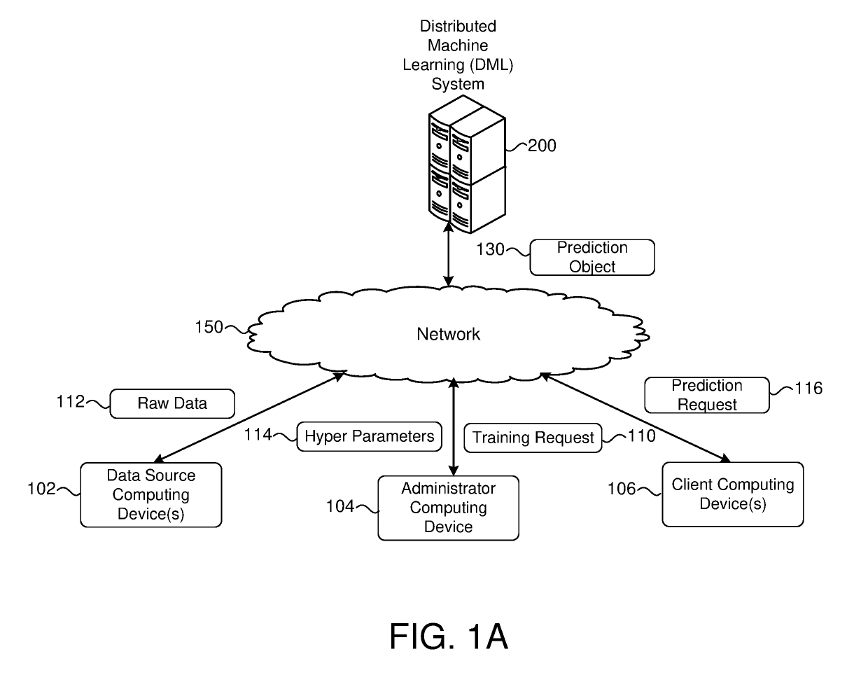

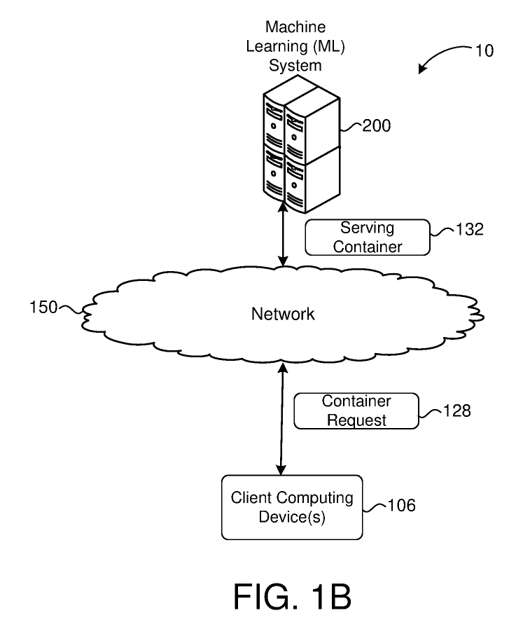

FIG. 1A illustrates an example environment of a DML system 200. The DML system 200 may be in communication with one or more data source computing devices 102 (“data sources”) and one or more client computing devices 106. In some scenarios, a data source 102 and a client computing device 106 may be the same device. A data source 102 transmits raw data 112 to the DML system 200. Raw data 112 may be structured or unstructured data that is collected by the data source or a connected computing system. The raw data 112 includes at least two types of data, whereby at least some of the data is outcome data. For example, a collection of data sources 102 may support an agriculture-related application that collects and aggregates raw data 112 relating to crops and crop yields. The agriculture-related application may collect information such as a geolocation of a plot of land, a type of crop being grown, the types of fertilizers used, the pH balances of the soil, the amount of rainfall during the life of the crop, the average temperatures during the life of the crops, and the crop yield. For each farm, the agriculture-related application may collect and report this as raw data 112. In this example, the crop yield may be the outcome data, whereby the other data may or may not be relevant to the crop yield. Put another way, the crop yield is a function of one or more of the other types of data, while the influence of each respective type of data on crop yield may be unknown.

The DML system 200 receives the raw data 112 and trains a model based on the raw data 112 and a model architecture. The model architecture may be selected by an administrator operating an administrator computing device 104. As previously mentioned, a model architecture may include one or more software libraries and/or additional instructions that, when executed, cause a container to operate on a particular type of model pertaining to the model architecture. The DML system 200 supports a plurality of model architectures and the administrator selects the model architecture from the administrator computing device 104. The administrator computing device 104 includes the administrator selection of the model architecture in a set of hyper parameters 114. The hyper parameters 114 can define any parameters related to the training of a model. For example, the hyper parameters 114 may include, but are not limited to, the model architecture type, a base learning rate of the model (typically beginning at 0.01 or 0.05 and iteratively decreasing by fractions of a percent), a base learning rate modification function, a number of iterations to perform on the training data, a momentum value (e.g., 0.9), a number of classifications by the model, a number of convolution layers, and a number of fully connected layers. The types of hyper parameters 114 accepted by the DML system may vary based on the selection of a model architecture. For example, the hyper parameters 114 corresponding to neural network architectures may include parameters defining the amount of different types of layers, while hyper parameters corresponding to different clustering architectures may include parameters that define the number of clusters or the number of members in each cluster.

The DML system 200 receives the hyper parameters 114 and generates one or more training containers based on the received hyper parameters 114 and the raw data 112. In some scenarios, the raw data 112 may be stored by the DML system 200. In other scenarios, the raw data 112 may be stored by a third party and requested by the DML system at training time. The raw data 112 may include structured and/or unstructured data. In the case of unstructured data, the DML system 200 may structure the data according to an ontology. The DML system 200 may structure the raw data into a series of “events.” Each event may include one or more input signals and one or more outcome signals. An outcome signal represents a value that a to-be generated model seeks to predict based on one or more input signals and the model. In the example of the agricultural application described above, the outcome signal would be the crop yield, while the other data types represent input signals. The DML system may structure the raw data into a collection of individual events, whereby the structured collection of data may be referred to as a training data set.

The DML system 200 may include a scheduler (not shown in FIG. 1A) that assigns training and/or prediction tasks to various resources of the DML system 200. For instance, some training tasks may require a graphical processing unit (GPU) while other training tasks may have higher priority than other tasks. The scheduler maintains a queue of tasks and also monitors the availability of the computing resources of the DML system 200. The scheduler assigns tasks to available resources based on the priority of a respective task, the minimum requirements of the respective task, and the available resources at the time.

In response to a training request, the DML system 200 creates a new container from a container image. The DML system 200 retrieves from its memory a container image corresponding to the model architecture type. The container image contains the model architecture (e.g., computer readable instructions that support the matrix operations and other processes tied that define the model architecture) and a filesystem. The scheduler of the DML system 200 may then identify one or more computing resources to which it assigns a training or prediction task. Once the scheduler has assigned a task to the computing resources, the DML system 200 may begin running the container configured to perform the task. The DML system 200 mounts a set of structured training data (also referred to as the “volume” of training data) to the filesystem of the container. The DML system 200 may create a specific directory for input data or may use a default “input” directory in the filesystem. The volume of training data may be mounted in the directory of the input data. To the extent the filesystem of the container does not include a specific directory for output, the DML system 200 creates a directory for the output of the container.

In addition to the training data, the DML system may pre-load a base model to the filesystem of the container. A base model may be any suitable model that is compatible with the model architecture. In some scenarios, the base model may be a previously learned model. For instance, if the container is being configured to train an image classifier using a deep neural network, the previously learned model may have been fine-tuned at lower levels, whereby the model weights are trained to identify edges and shapes. In other scenarios, the base model may be populated with random values and/or a pattern of values that have no connection to the training task. In this scenario, the training task may begin with little or no a priori knowledge, such that the lower levels of the model are also trained using the training data. In other scenarios, the base model may be a previous version of the model to be trained, whereby the container is updating the model weights in the model using newly received training data.

The DML system 200 further configures and/or customizes the model architecture in the container image using any relevant hyper parameters received in the training request, including the learning rate, the base learning rate modification function, and the number of iterations to perform. The DML system 200 may configure the model architecture with other additional or alternative hyper parameters as well. At this point, the container may operate on the volume of training data according to the model architecture and hyper parameters. The container executes the prescribed number of iterations, iteratively updating the weights defined in the model (which began as the base model). Once a training container completes the prescribed number of iterations, the training container stores the resultant model in its output directory. The model may include a number of different classifications. To the DML system, the classifications may be represented by respective numerical values. In some implementations, the DML system 200 may label each classification with a respective name, the collection of which may be referred to as a set of classification labels. The set of classification labels may be human-generated strings that represent different groups of objects. The DML system may include the set of classifications in the output directory. A training container may include additional metadata in its output directory, including the hyper parameters used to train the model. The combination of data stored in the output directory, as well as any metadata relating to the model, may be referred to as a model bundle. Upon completion of a training task, the DML system 200 may obtain the model bundle from the container and then store the model bundle in persistent memory of the DML system. In this way, a model stored in a model bundle may be used at a later time in a serving container. In some implementations, the DML system 200 may compress the model bundle (e.g., by “tarring” or “zipping” the output directory). The DML system 200 may then stop running the container.

In the example of FIG. 1A, the DML system 200 executes a serving container and outputs a prediction to a requesting client computing device 106. In some implementations, a prediction may include one or more possible classifications, and for each classification, a confidence score corresponding thereto. The confidence score indicates a probability that the classification is correct given the model used to generate the prediction. The manner by which a serving container determines classifications and the confidence scores depends on the model architecture employed in a serving container.

In operation, a client computing device 106 may transmit a prediction request 116 to the DML system 200. The prediction request 116 may indicate a model bundle. A prediction request 116 may include additional data, such as a source of input signals (e.g., a URL or the like). The model bundle includes the model (e.g., a matrix containing the model weights), classification labels, and any other metadata relating to the training of the model. The DML system 200 may then retrieve a serving container image configured with a model architecture that corresponds to the model architecture used to train the model. For instance, the serving container image may include the entire model architecture used to train the model or may include a complementary portion of the model architecture that is configured to utilize the model rather than train the model. It is noted that by storing container images separately from individual model bundles, updates to a model architecture may be made once to the container image configured with the model architecture without having to update each serving container implementing the model architecture that would have been generated at the time the respective model was trained. The scheduler of the DML system 200 may assign the serving container to one or more computing resources based on the priority of the task, the available resources, and other suitable factors. The DML system 200 then mounts the model to the serving container image to obtain a serving container and starts running the serving container. Once running, the serving container begins receiving input signals from one or more data sources 102. The input signals may be structured events, structured in a manner similar to the training data. In response to the input signals, the serving container outputs predictions. A prediction may include one or more classifications. Furthermore, a prediction may include a confidence score corresponding to each respective classification. The DML system 200 may return a prediction object 130 to the client computing device 106. The prediction object may be a data object (e.g., a JSON file) that includes the prediction (e.g., a classification and a confidence score), as well as other pertinent data. In some implementations, the client computing device 106 may return feedback data (not shown) to update the model. The feedback data may be outcome data corresponding to a specific set of input signals.

In the example of FIG. 1B, the DML system 200 serves serving containers 132 to a client computing device 106. In this example, the client computing device 106 requests a serving container 118 via a container request 128. The container request 128 may indicate a model bundle. In response to the container request 128, the DML system 200 generates a serving container 132 based on the model bundle and a serving container image. The DML system 200 then transmits the serving container 132 to the client computing device 106. The client computing device 106 runs the serving container 132. The client computing device 106 can then feed input signals to the deployed serving container 132. In this way, the client computing device 106 may obtain predictions from the deployed serving container in an offline condition. For example, the client computing device 106 may be an autonomous vehicle. In such a situation, the client computing device 106 may benefit from having a container deployed at the vehicle, as opposed to relying on a constant communication channel with the DML system 200 to obtain predictions.

In some implementations, the DML system 200 includes an application program interface (API) that allows communication between the data sources 102, the administrator computing devices 104, and/or the client computing devices 106. In some of these implementations, the API may be a private API that only allows authorized computing devices to interact with the DML system. The API can be used to provide raw data 112 to a training container. Additionally or alternatively, the API can be used to provide input signals to a serving container and/or to return prediction objects to a client computing device 106.

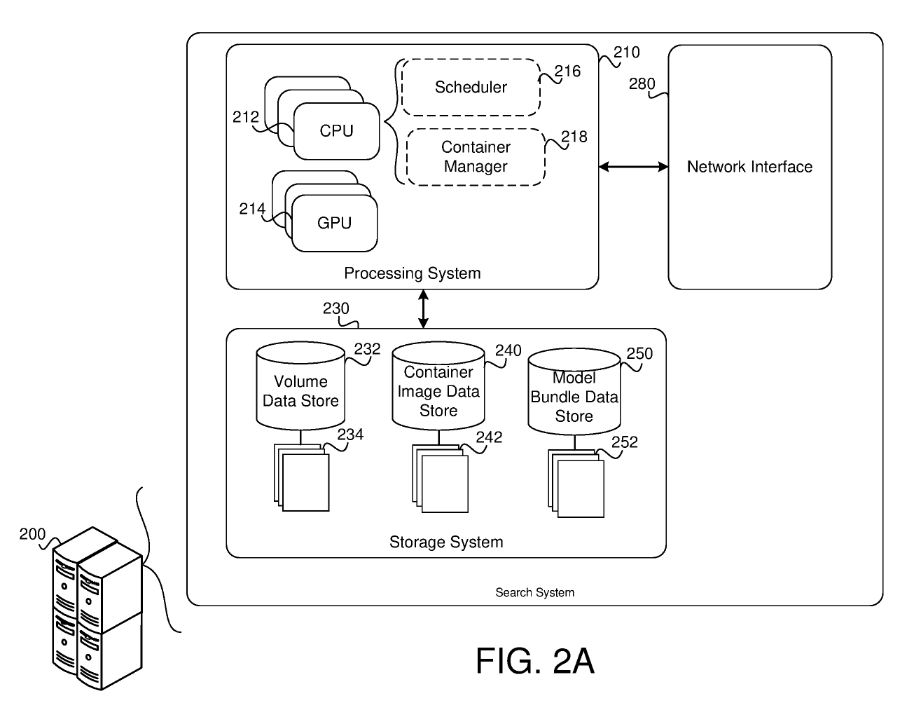

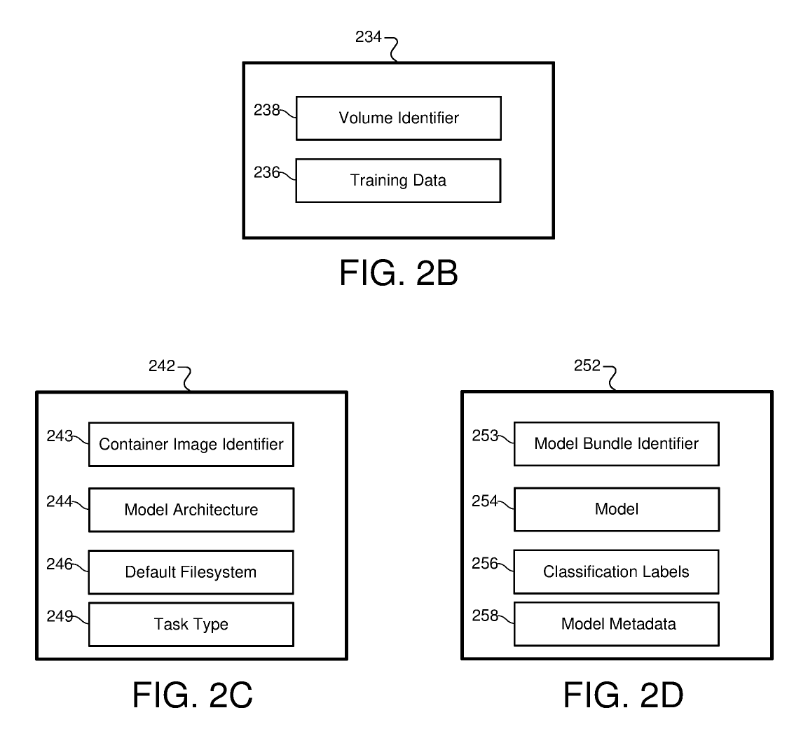

FIG. 2A illustrates an example set of components of a DML system 200. In the illustrated example, the DML system includes a processing system 210, a storage system 230, and a network interface 280. The DML system 200 may include additional components now shown in FIG. 2A.

The processing system 210 may include one or more central processing units (CPUs) 212 and/or one or more graphics processing units (GPUs) 214. The processing units (GPUs 214 and/or CPUs 212) may operate in an independent or distributed manner. The processing units may be connected with a bus and/or via a communication network. The one or more CPUs 212 may execute a scheduler 216 and a container manager 218, both of which may be embodied by computer-executable instructions. Additionally, the CPUs 212 and/or the GPUs 214 execute one or more containers (not shown).

The network interface 280 includes one or more devices that can perform wired or wireless (e.g., Wi-Fi or cellular) communication. Examples of the network interface 280 include, but are not limited to, a transceiver configured to perform communications using the IEEE 802.11 wireless standard, an Ethernet port, a wireless transmitter, and a universal serial bus (USB) port.

The storage system 230 includes one or more non-transient memory devices. The memory devices may be any suitable type of computer readable mediums, including but not limited to read-only memory, solid state memory devices, flash memory devices, hard disk memory devices, and optical disk drives. The memory devices may be connected via a bus and/or a network. Storage devices may be located at the same physical location (e.g., in the same device and/or the same data center) or may be distributed across multiple physical locations (e.g., across multiple data centers). The storage system 230 can store a volume data store 232, a container image data store 240, and a model bundle data store 250.

The volume data store 232 stores volumes 234 of training data 236. FIG. 2B illustrates an example of the data contained in a volume 234 according to some implementations of this disclosure. A volume 234 of training data may refer to a set of training data 236 that pertains to a particular training task. A volume 234 may include structured training data 236 and a volume identifier 238. The volume identifier is a unique value assigned to the volume 234 that identifies the volume 234 from other volumes 234 stored in the volume data store 232. When the DML system 200 receives a new set of training data 236, the DML system 200 creates a new volume 234 of training data and assigns a new volume identifier 238 to the volume 234.

Each volume 234 contains training data 236. Each volume is structured into a set of events (not shown). An event includes one or more observations and one or more outcomes. The observations may be measured values. For example, in a volume 234 of training data 236 used to train an image classifier, each event may correspond to a respective image. The observations may include the color values of each pixel. In this example, an outcome may be a classification of the image. This specific volume 234 may include such observations and outcomes for thousands or millions of images. In another example, a different volume 234 of training data 236 may be used to train a model for predicting crop growths. In this example, the observations may include a crop type, a geolocation of the crop (e.g., a latitude of the farm and a longitude of the farm), a total amount of precipitation during the lifetime of the crop, an amount of rainfall during each day during the lifetime of the crop, daily high temperatures during the lifetime of the crop, daily low temperatures during the lifetime of the crop, a type of fertilizer used, and other suitable related data. The outcomes in this example may be the crop yield per acre. In this example, each event pertains to a particular harvest and the volume relates to harvests from a plurality of different locations.

The training data 236 is structured data. The training data 236 may be structured according to a respective ontology. The ontology defines the different types of data defined in an event. The raw data 112 on which training data 236 is based may be received as structured data or unstructured data. To the extent the raw data 112 is unstructured, the DML system 200 may be configured to structure the raw data 112 according to a custom ontology and known techniques. For example, the DML system 200 may receive the raw data and perform in-memory data processing such as map-reduce-merge to structure the raw data.

The container image data store 240 stores container images 242. FIG. 2C illustrates an example of the data contained in or associated with a container image 242 according to some implementations of this disclosure. Each container image 242 may include a model architecture 244 and a default filesystem 246. The container image 242 may further include metadata such as a container image identifier 243 and a task type 249.

The model architecture 244 includes one or more software libraries that support a particular machine learning technique (e.g., decision tree learning, clustering, neural networks, deep learning neural networks, support vector machines, linear regression, logistic regression, naïve Bayes classifiers, k-nearest neighbor, k-means clustering, random forests, gradient boosting, and other suitable model architectures). A software library of a model architecture may define different operations (e.g., matrix operations) that are performed on a model or using a model. For example, the software libraries may define matrix operations that recombine some set of input features to produce an output vector. Furthermore, the software libraries may include one or more configurable parameters. For instance, a software library supporting any type of neural network machine learning technique may include parameters that define a number of convolution layers, a number of fully connected layers, and/or a number of classifications. In some implementations, these parameters are initially set to default values. These parameters may be set at run time based on the hyper parameters received in a request received from an administrator computing device.

The default filesystem 246 may contain one or more directories, including a root directory. Additionally, the filesystem 246 may include one or more directories that store the model architecture 244. The default filesystem 246 may initially include one or more unpopulated directories. For example, the default filesystem 246 in a training container image may include an input directory and an output directly, whereby the DML system 200 mounts a volume of training data to the input directory and the container stores the resultant model in the output directory. At run time, the DML system 200 mounts a volume to the filesystem 246.

The container image identifier 243 identifies the container image 242 from other container images. In some implementations, the container image identifier 243 is a value that is indicative of the model architecture type of the container image 242. The container image data store 240 may include an index that indexes the container images based on the respective container image identifiers 243. The task type 249 may be a flag that indicates whether the container image is a training container image or a serving container image. In some scenarios, a serving container may require a different set of operations from within a particular model architecture. In these scenarios, a task type 249 may be used to differentiate between training container images and serving container images that employ the same machine learning techniques.

The model bundle data store 250 stores model bundles 252. FIG. 2D illustrates an example of the data contained in or associated with a model bundle 252 according to some implementations of this disclosure. A model bundle 252 can include a model bundle identifier 253, a model 254 (e.g., a matrix of weights) and, in some scenarios, a set of classification labels 256. In some implementations, a model bundle 252 further includes metadata 258 relating to the model. In some implementations, a model bundle 252 is stored in a compressed state.

The model bundle identifier 253 identifies the model bundle 252 from other model bundles 252. The model bundle data store 250 may be indexed according to the respective model bundle identifiers 253 of the model bundles 252. In this way, a model bundle 252 can be retrieved using its respective model bundle identifier 253.

The model 254 is any suitable model that is a result of a machine learning technique. In many cases, a model 254 is a matrix of weights, where each element in the matrix represents a weight. For example, in some model architectures the columns represent the output features (e.g., potential classifications) and the rows represent the input features. The value at a particular row and column expresses the weight associated between the input feature corresponding to the row and the output feature corresponding to the column. The weight indicates a strength of the signal between the particular input/output combinations. The weight may be multiplied by the value of an input value, the result of which may be summed with values computed on all rows in the same column to obtain a classification or a value used to determine a classification.

The set of classification labels 256 may be a set of natural language strings that are assigned to each potential classification. As previously discussed, many machine learning algorithms aim to output a classification. Thus, each potential classification may be assigned a label by, for example, a human administrator. In this way, when the model is used to predict a classification, the output of the model may include a human understandable classification.

The model metadata 258 may be any data that is associated with the model 254, or the generation thereof. In some implementations, the DML system 200 may store previous versions of the model 254. In these implementations, the metadata may include the previous versions of the model 254 or memory locations of the previous versions. In some implementations, the metadata may include the training data used to train the model 254 or a volume identifier thereof.

The foregoing are examples of data stores that may be implemented by the DML system. The DML system 200 may store additional types of data without departing from the scope of the disclosure.

As mentioned, the processing system may execute a scheduler 216. In some implementations, the scheduler 216 receives a training request 110 from an administrator computing device 104. The training request 110 may include one or more hyper parameters 114. The hyper parameters 114 may designate a model architecture type. In response to the request, the scheduler 216 may determine a priority of the request, as well as the resources required to perform the training job indicated by the training request. The scheduler 216 may generate a training task, whereby the training task indicates the priority of the training task and the resources required to perform the job indicated by the training task.

In some implementations, the scheduler 216 receives prediction requests 116 from client computing devices 106 and/or administrator computing devices 104. The request may indicate a model bundle 252 by its respective model bundle identifier 253. In response to the request, the scheduler 216 determines a priority of the request, as well as the resources required to perform the requested prediction job. The scheduler 216 may generate a prediction task, whereby the prediction task indicates the priority of the prediction task and the resources required to complete the job indicated by prediction task.

In some implementations, the scheduler 216 maintains a priority queue. The priority queue indicates at any given time, an order by which the tasks requested of the DML system 200 are to be performed. Each item in the priority queue indicates a different task (e.g., a training task or prediction task) for the DML system to perform, whereby performance of the task includes the deployment of a respective container to one or more of the CPUs 212 or GPUs 214. The priority queue dictates the order by which a container is executed relative to other containers. Furthermore each task may indicate the minimum required resources for the task. For instance, a training task to train an image classifier may require one or more GPUs 214, while a prediction task relating to a document classifier may only require a single CPU 212. The scheduler orders the priority queue based on a number of factors, including the order in which a task is received, the resources required by the task, the urgency of a task, or other considerations. In some implementations, certain client computing devices or administrators may be granted higher priority than other third parties. For example, tasks requested by a premium user of the DML system 200 may be granted higher priority than tasks requested by a non-premium member.

The scheduler 216 further maintains a list of available computing resources. In some implementations, the list of available computing resources indicates CPUs 212 and GPUs 214 that are currently not being used. In some implementations, the scheduler 216 queries the CPUs 212 and GPUs 214 of the processing system 210 to determine which resources are available.

As the scheduler 216 receives training requests 110 and prediction requests 116, the scheduler 216 generates task objects and places the task objects in the priority queue. In some implementations, the task object indicates one or more of the machine learning job to be performed (e.g., prediction or training), a model architecture of the job, the minimum resources required and a container image to be used. In some implementations, if the job is a training job, the task object may reference the volume 234 of training data to be used as well as the hyper parameters received with the training request 110. In some implementations, if the job is a prediction job, the task object may reference a model bundle 252. Upon receiving a training request 110 and/or a prediction request 116, the scheduler 216 generates a task object corresponding to the request. The scheduler 216 can determine a priority of the job. In some implementations, the priority is based on the source of the request and/or the type of request. For instance, if the source of the request is a premium user, the job may be granted a higher priority than that of a non-premium user. The scheduler 216 may also determine the minimum required resources for the job. In some implementations, the scheduler 216 determines the minimum required resources based on the model architecture and the hyper parameters. For instance, a training job that operates on images may require at least one GPU 214. Furthermore, if the number of convolution layers in the model, as define by the hyper parameters in this example, is relatively high (e.g., greater than 20), the scheduler 216 may determine that the minimum number of GPUs 214 is two. The scheduler 216 may employ a look-up table and/or business logic to determine the minimum required resources for a job.

Upon generating a new task object, the scheduler 216 updates the priority queue. In some implementations, the scheduler 216 inserts a task object in the queue such that the inserted task object is the last object having the same priority. Put another way, the scheduler 216 may identify the task objects in the priority queue having the same priority as the new task object, and inserts the new task object in a position in the priority queue that is directly after the last of the scheduled task objects having the same priority.

As mentioned, in some implementations the scheduler 216 maintains a list of available resources. Upon the scheduler 216 determining that one or more computing resources have become available, the scheduler 216 removes a task object to assign to the one or more available resources. In some implementations, the scheduler 216 begins at the beginning of the queue (the highest priority task) and selects a task object to the extent it can be performed on the available resources. For example, if the task object having the highest priority requires a GPU 214 but the only available resource is a CPU 212, the scheduler 216 will pass this task object over to identify the next task object that only requires a single CPU 212. Once a task object defining a minimum amount of resources that can be satisfied by the available resources is identified, the scheduler can remove the task object from the priority queue and can pass the task object to the container manager 218.

In some implementations, the container manager 218 receives task objects from the scheduler 216. In response to a task object, the container manager 218 deploys a new container based on the received task object. In some implementations, the container manager 218 retrieves a container image 242 from the container image data store 240 based on the model architecture type indicated in the task object.

When the task object indicates a training job, the container manager 218 may further determine a base model on which to base the training task on. In some scenarios, the container manager 218 may select a base model from a previous training session (e.g., in the case of updating a model). In other scenarios, the container manager 218 may use a default model as the base model (e.g., using a generic image classification model to train a customized image classification model). In other scenarios, the container manager 218 may begin with a randomly initialized base model (e.g., beginning a training task with no a priori knowledge).

In some implementations, the container manager 218 retrieves a volume 234 of training data from the volume data store 232 based on the volume 234 indicated in the task object. In some implementations, the container manager 218 retrieves the volume 234 from a remote resource. For example, in some implementations the volume of data may be referenced by a URL. In these implementations, the container manager 218 may issue a request (e.g., HTTP or FTP request) to the resource to obtain the volume. The container manager 218 mounts the volume of training data to the filesystem of the container image 242. In some implementations, the default filesystem of the container image 242 includes a subdirectory that stores training data. Thus, the container manager 218 may mount the volume in this subdirectory, thereby creating a training container.

In some implementations, the container manager 218 may also configure the training container using the hyper parameters. The container manager 218 may set certain variables defined in the model architecture based on the received hyper parameters. For example, the container manager 218 may define the number of convolution layers, the number of fully connected layers, and the number of classifications in the model architecture based on the hyper parameters defined in the training request 110. Additionally or alternatively, the container manager 218 may set the base learning rate within the model architecture, the base learning rate modification function of the model architecture, the momentum of the model architecture, the weight decay value, and/or the number of iterations to be run by the training container. In this way, a training container may be customized by an administrator using the hyper parameters.

Upon mounting a volume 234 of training data and initializing the model architecture, the container manager 218 can deploy the training container on the appropriate computing resource. For instance, the container manager 218 can run a training container for training an image classifier on two or more available GPUs 214. The training container executes the computer executable instructions contained in the model architecture, which define operations to be performed on the matrix given the training data. As a training container executes, the training container updates the model at each iteration. The model may be stored in a specific subdirectory of the filesystem. For instance, the default filesystem of the training container may include an “output” subdirectory. Upon completing the training job (e.g., after the number of iterations defined in the hyper parameters), the training container stores the resultant model in the output subdirectory of the training container. In some implementations, the training container may further receive labels for each of the potential classifications. Each label may represent a different classification. The labels may be provided by a human administrator or the like.

In some implementations, the training container may also output the model, as well as any other additional data to the container manager 218 (or another suitable module) upon completing the training job. In response to receiving the model, the container manager 218 may store the model, as well as any other additional data in the model bundle data store 250. The other data may include the labels assigned to the classifications defined in the model, a version number of the model, the training data used to train the model (or a reference thereto), a training log, and/or the hyper parameters used to train the model. Each of these additional items of data may be stored in the same subdirectory (e.g., “output” subdirectory) as the model. In some implementations, the container manager 218 may compress the subdirectory in which the model is stored to obtain the model bundle 252. The container manager 218 may then store the model bundle in the model bundle data store 250. In these implementations, the model is not written to a serving container that implements the same type of model architecture used to train the model. In this way, updates can be made to the model architecture in a single container image rather than having to update each and every container containing a model trained using the model architecture.

In some implementations, the container manager 218 may be configured to perform batch training jobs. In these implementations, the container manager 218 may deploy multiple training containers that operate on different segments of the same volume of training data. In some of these implementations, the container manager 218 may randomly separate the events defined in the volume into equally sized groups, whereby each group may be a different volume that is mounted to a respective container image. These training containers may be run in parallel, such that the respective containers are operating on smaller data sets, thereby reducing the overall training time. Upon completing the batch training, the container manager 218 can merge the resulting models. For example, the container manager 218 can average the model weights defined in the collection of batch trained models.

When the task object indicates a prediction job, the container manager 218 retrieves a model bundle 252 from the model bundle data store 250 based on the model bundle indicated in the task object. In some implementations, the container manager 218 decompresses the model bundle 252 (e.g., using an—untar command) and extracts the model 254 therefrom. The container manager 218 also retrieves a container image 242 corresponding to the model architecture used to train the model. The container image 242 contains one or more software libraries that define operations that are configured to operate on the model 254. Put another way, the container image 242 is configured to operate on input signals using the model 254 to issue predictions. The container manager 218 mounts the model 254 to the filesystem of the container image 242 to obtain a serving container.

The container manager 218 deploys the serving container on the available resources. In some implementations, the container manager 218 runs the serving container on one or more available CPUs 212 and/or GPUs 214. The serving container may initiate a communication session with one or more remote devices to receive input signals. Upon initiating a communication session, the serving container receives input signals. The serving container outputs predictions based on the input signals, the model architecture, and the model. In particular, the model architecture defines operations to perform on the model given the input signals to obtain a prediction. In some scenarios, the prediction may indicate one or more classifications. Each prediction may further include a confidence score for each of the one or more classifications. The confidence score indicates the likelihood that the classification is correct given the received input signals and the model. Each time the serving container outputs a prediction, the serving container may transmit the prediction to the client computing device 106 and/or the remote computing device that provides the input signals. In some implementations, the serving container may generate a prediction object that contains the prediction. The prediction object may be, for example, a .JSON file that contains the prediction. The prediction object may include one or more classifications and respective confidence scores for each of the one or more classifications. Furthermore, the prediction object may include the input signals on which the prediction is based. The serving container can continue to execute for a prescribed amount of time and/or until a user ends a session. To end a session, the container manager 218 terminates the container and deallocates the memory allocated to the container.

In some implementations, the DML system 200 receives container requests 120 from a client computing device 106 (e.g., FIG. 1B). In response to such requests, the container manager 218 may be configured to retrieve the model 254 and container image 242 in the manner described above. The container manager 218 may mount the model 254 to the container image 242, thereby obtaining a serving container. The container manager 218 may transmit the serving container to the client computing device 106.

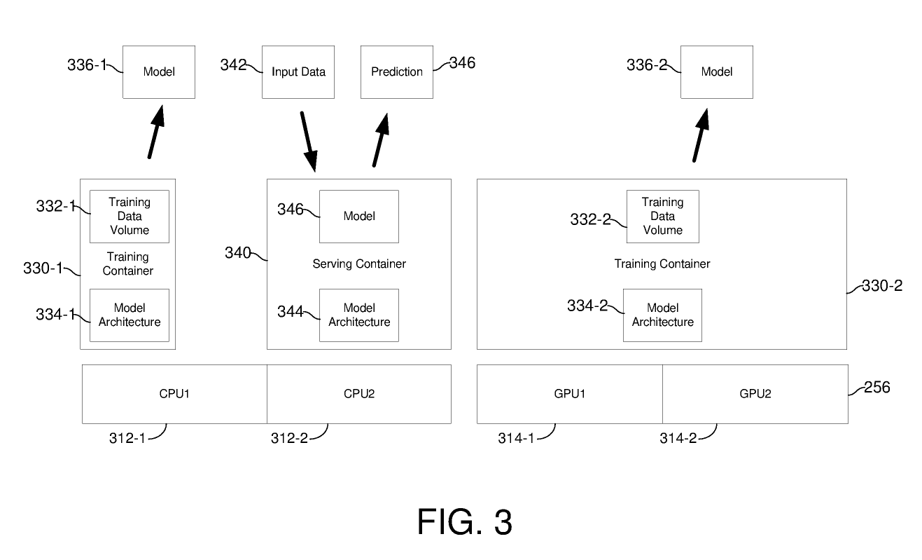

FIG. 3 illustrates an example of the DML system 200 executing a plurality of different containers. In the illustrated example, the DML system 200 includes a first CPU 312-1, a second CPU 312-2, a first GPU 314-1, and a second GPU 314-2. The first CPU 312-1 is executing a first training container 320-1. The first training container 330-1 includes a first volume 332-1 of training data and a first model architecture 334-1. The first training container 330-1 executes the operations defined by the first model architecture 334-1 on the training data defined in the first volume 332-1 to obtain a first model 336-1. The first training container 330-1 outputs the model 336-1, such that the DML system 200 stores the first model 336-1 in a model bundle in the storage system 230. In this way, the first model 336-1 may be used after the container stops executing.

In this example, a second training container 330-2 is executing on the first GPU 314-1 and the second GPU 314-2. In this example, the training job being performed by the second training container 330-2 may require more powerful resources than the training job being performed by the first training container 330-1. For example, the second training container 330-2 may be training an image classification model using a deep neural network, while the first training container 330-1 may be training a document classification model using a neural network without many convolution layers. Thus, the second training container 330-2 is executed on the two GPUS 314-1, 314-2 as opposed to a single CPU 312-1. The second training container 330-2 executes a second model architecture 334-2 that operates on a second volume of data 332-2. The second training container 330-2 outputs a second model 336-2, which the DML system 200 may store in the storage system 230.

In the example of FIG. 3, the DML system 200 is also executing a serving container 340 at the second CPU 312-2. The serving container 340 receives input signals 342 from a remote source (not shown). The serving container 340 executes one or more operations defined in a third model architecture 344 to analyze the input signals 342 using a previously learned model 346. The input signals 342 correspond to a particular event. For example, the input signals may include a geolocation, an estimated temperature at the geolocation for a period of time (e.g., a growing season), and an estimated amount of rainfall at the geolocation over the period of time. Given the model 346 and the model architecture, the serving container 340 generates a prediction 348 based on the input signals 342. The prediction 348 may include one or more classifications of the event or predicted outcomes, and in some implementations, a confidence score for each of the one or more classifications. For example, in response to the input signals provided above, the serving container 340 may predict an estimated crop yield for a growing season or a range of estimated crop yields over the growing season. The serving container 340 outputs each prediction 348 to a client computing device (not shown).

The foregoing example of FIG. 3 is meant to illustrate the distributed nature of the containers. In this example, each container is silo'd from the other containers, but may interact simultaneously or nearly simultaneously with the same kernel. The DML system 200 described with respect to FIGS. 2A-3 may help improve fault tolerance in machine learning tasks. Additionally or alternatively, the DML system 200 may also provide a mechanism to parallelize a machine learning job in a scalable manner.

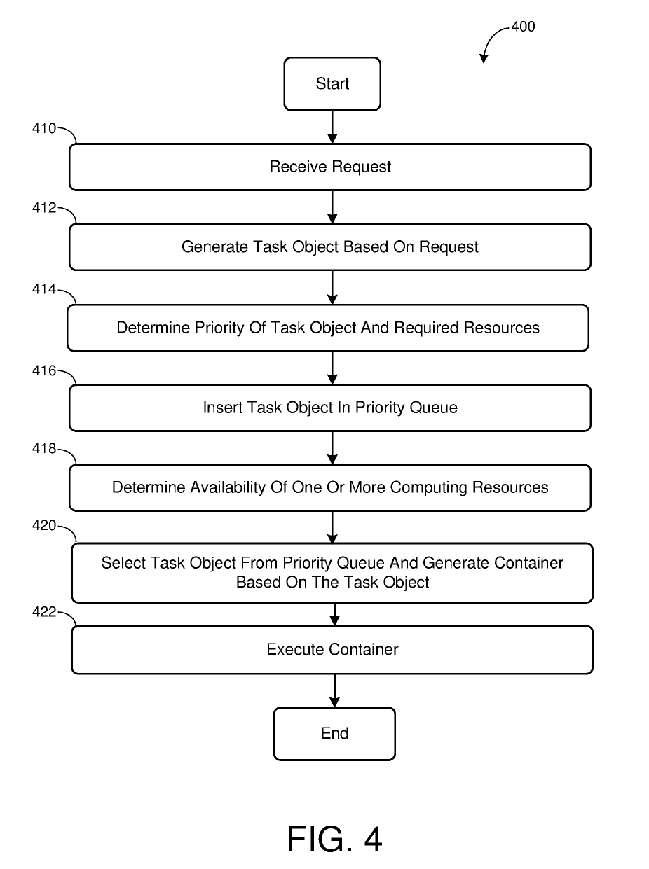

FIG. 4 illustrates an example set of operations of a method 400 for operating a DML system. The operations are provided for example and not intended to limit the scope of the disclosure. Furthermore, the operations may be divided into multiple sub-operations.

At 410, the DML system receives a request. The request may be a training request or a prediction request. In the case of a training request, the request may include a set of hyper parameters. At 412, the DML system generates a task object based on the request. The task object may indicate the type of task, the type of resources required, a model architecture, and a priority. At 414, the DML system determines the priority of the task and the minimum required resources to perform the task. The DML system may determine the priority of the task based on the source of the request. For instance, tasks sourced by organizations that have premium memberships may be given higher priority than organizations that have free memberships. The DML system may determine the resources required based on a number of factors, including the model architecture, the type of training data (e.g., images require more resources than text), and the size of a volume of training data. In some implementations, the DML system may employ a lookup table to determine the minimum required resources. In some implementations, the DML system may employ a formula that determines the minimum required resources. Once determined, the DML system may update the task object to include the priority and the minimum required resources. At 416, the DML system inserts the task object in the priority queue based on the priority of the task object. The DML system may insert the task object into the queue based on the priority of the task object relative to the other task objects already in the queue. In some implementations, the DML system inserts the task object in the priority queue such that the task object is queued before any task object having less priority, but after any task object having equal or greater priority.

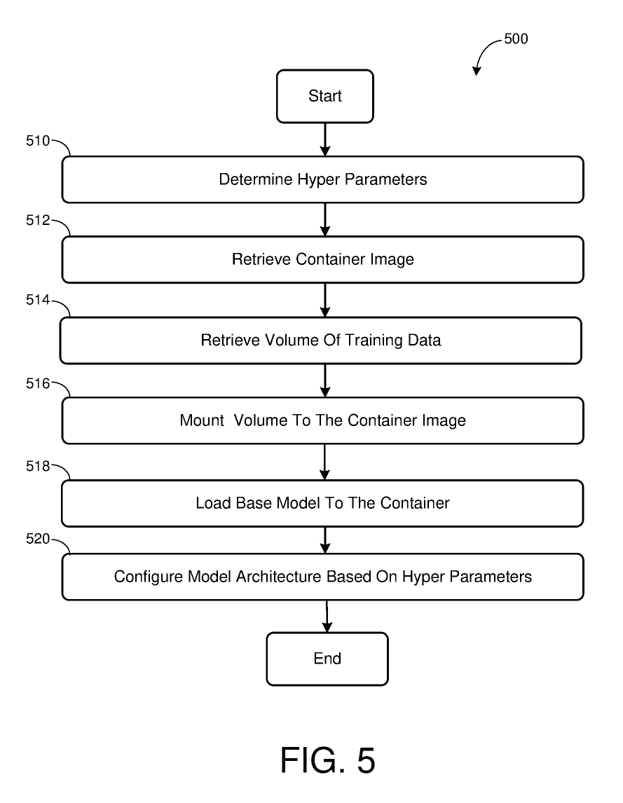

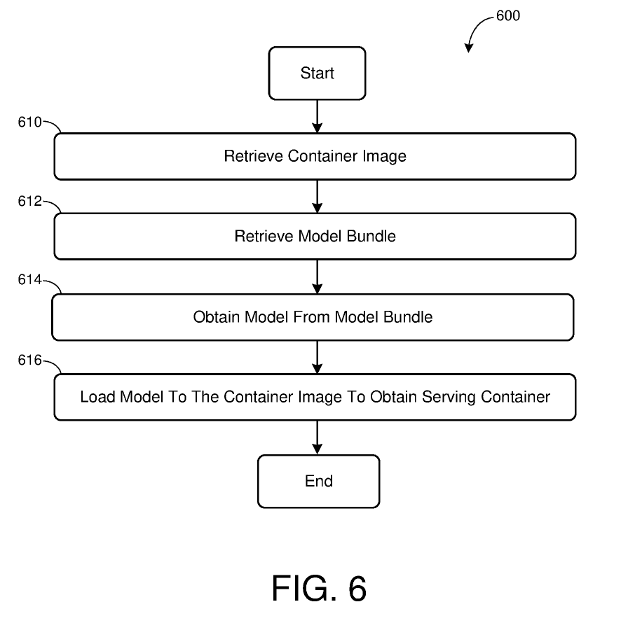

At 418, the DML system determines that one or more computing resources are available. In some implementations, the DML system continuously monitors the computing resources of the DML system to maintain a list of available resources. As the resources become available, the DML system may iterate up the priority queue to identify the task object having the highest priority that can be performed given the available resources. Once such a task object is identified, the DML system may remove the task object from the priority queue. The DML system may then generate a container, as shown at 420. Operation 420 is described in greater detail with respect to FIGS. 5 and 6.

At 422, the DML system executes the container. For example, in some implementations the DML system 200 executes a command to run the container (e.g., “docker run-it ubuntu: 16.06”). In these implementations, the may be a Docker daemon that is executed by the DML system that may receive a command via a network socket to start the container. The Docker daemon may use “containerd” to run the container.

FIG. 5 illustrates an example set of operations of a method 500 for generating a training container. The operations may be performed in response to a task object defining a training job being selected from the priority queue.

At 510, the DML system determines the hyper parameters from the task object. The hyper parameters may include the model architecture for the training job. Furthermore, depending on the model architecture selected, the hyper parameters may further include a base learning rate of the model (typically beginning at 0.01 or 0.05 and iteratively decreasing by fractions of a percent), a base learning rate modification function, a number of iterations to perform on the training data, a momentum value (e.g., 0.9), a number of classifications by the model, a number of convolution layers in the model, and a number of fully connected layers in the model. The hyper parameters may include additional or alternative hyper parameters, depending on the model architecture.

At 512, the DML system retrieves a container image based on the type of model architecture defined in the hyper parameters. The container image includes a model architecture and a file system but does not include any of the training data that will be used to train a model. At 514, the DML system retrieves a volume of training data. The volume of training data may be stored at the DML system or may be retrieved from a third party remote data source. In the latter scenarios, the DML system may obtain the volume via an HTTP or FTP transfer. At 516, the DML system mounts the volume of training data to the container image to obtain the training container. The DML system may mount the volume in a specific directory of the container's filesystem.

At 518, the DML system loads a base model onto the container. The base model may be a previously learned version of a model, a generic model, or a randomly initialized model. In the case that the training job is directed to updating a previously learned model, the DML system may utilize the previously learned model, whereby the container operates on the previously learned model using newly received training data. In the case of a new training task, the DML system may utilize a generic base model or a randomly initialized base model. A generic base model may have lower layers that are already well established, which may serve to reduce the amount of iterations to train the model. For instance, in the case of training a model for predicting whether an image infringes copyrighted material, the lower levels of a generic base model may define horizontal edges, vertical edges, and basic shapes, but may not include any useful weights for determining whether a particular image is similar to a known image. The generic base model may include weights associated with identifying horizontal edges, vertical edges, and basic shapes but may not be trained with any specific images of copyrighted material. In the case of a new training job without any a priori knowledge, the DML system may utilize a randomly initialized base model. A randomly initialized base model may include any suitable values as weights. These types of training jobs may require additional time, as the training process will include fine tuning the lower levels of the model, which increases the amount of time to train the model. The base models may be stored in and retrieved from the model bundle data store or any other suitable data store.

At 520, the DML system configures the model architecture based on the hyper parameters. Each model architecture may have one or more configurable parameters. For example, the hyper parameters may define a total number of iterations that are to be performed by the container. In response to this hyper parameter, the DML system may set the number of iterations defined in the model architecture equal to the value indicated in the hyper parameters. In another example, many types of neural network model architectures allow an administrator to set the number of convolution layers and the number of fully connected layers in the neural network via the hyper parameters. In this situation, the DML system may set one or more variables in the model architecture to reflect the number of convolution layers and the number of fully connected layers. In another example, an administrator may define the base learning rate and a base learning rate modification function. In response to these hyper parameters, the DML system may set a variable in the model architecture to reflect the base learning rate and may set the base learning modification function to the function defined in the hyper parameters by the administrator. The foregoing are examples of hyper parameters that may be configured in the model architecture. In another example, the hyper parameters may define a momentum of the learning and/or a weight decay value. The foregoing are examples are provided to demonstrate examples of configuring a model architecture. The DML system may allow an administrator to configure additional or alternative parameters in a model architecture without departing from the scope of the disclosure.

At this juncture, the container is a customized machine learner with a volume of training data to operate on. The DML system may run the container on the available resources (described above) to obtain a trained model. Once the container has executed, the container may output a trained model. The DML system may then store the model in a model bundle. In some implementations, the DML system also stores a set of labels for the classifications of the model, as well as other metadata.

FIG. 6 illustrates an example set of operations of a method for generating a serving container. The operations may be performed in response to a task object defining a serving job being selected from the priority queue.

At 612, the DML system retrieves a container image. In some implementations, the task object defines the type of model architecture and a particular model to use. The DML system may retrieve a container image that is configured with the model architecture identified in the task object. The container image may include a model architecture and a predefined filesystem. The model architecture may correspond to the architecture used to train models, but may define different operations as the model architecture is configured to use the model, rather than train the model. At 614, the DML system retrieves a model bundle. In some implementations, the DML system may retrieve a model bundle from a model bundle data store based on the model identified in the task object.

At 616, the DML system obtains the model from the model bundle. If the model bundle is compressed, the DML system may decompress the model bundle and extract the model from the decompressed model bundle. In some scenarios, the model bundle may further include a set of labels of the classifications defined in the model. In these scenarios, the DML system may also extract the set of labels from the model bundle. At 618, the DML system mounts the model to the container image to obtain a serving container. The DML system may mount the model to a predefined directory in the filesystem. The DML system may further label the different classifications in the model based on the set of labels defined in the model bundle.

At this juncture, the serving container is configured to issue predictions. The DML system may run the container. Once running, the container can communicate with remote computing devices to receive input signals. In response to a set of one or more input signals, an executing serving container outputs predictions that indicate one or more classifications, and in some implementations, confidence scores for each of the classifications.

FIGS. 4, 5, and 6 are provided for example and not intended to limit the scope of the disclosure. The method may include additional operations not explicitly discussed. Furthermore, the order of operations is not mandatory. Some operations may be performed in simultaneously or in a different order.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus,” “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method, comprising:
identifying one or more available computing resources from a plurality of computing resources, the plurality of computing resources including at least one central processing unit and at least one graphical processing unit;
receiving a task object that indicates a training job to perform and a type of model architecture to perform the training job;
retrieving a container image based on the type of model architecture, the container image including the model architecture and a default filesystem, the model architecture including one or more software libraries that define computer readable instructions that operate on a model;
retrieving a base model, the base model including a plurality of weights;
mounting the base model to the filesystem of the container image;
retrieving a volume of training data, the volume of training data defining a plurality of events, each event including at least one instance of observation data and at least one instance of outcome data;
mounting the volume of training data to the filesystem of the container image to obtain a training container;
executing the training container on at least one of the one or more available computing resources;
receiving a trained model from the container after the container completes the training job; and
storing the trained model in non-transitory memory, wherein the trained model is subsequently used to generate a serving container.

2. The method of claim 1, further comprising:
receiving a second task object that indicates a prediction job to perform and the trained model to be used to output predictions;
generating a serving container based on the trained model, the serving container including the trained model and a second model architecture that corresponds to the model architecture used to obtain the trained model;
executing the serving container on one or more available computing resources, wherein the serving container receives input signals from a remote computing device and outputs one or more classifications based on the input signals, the trained model, and the second model architecture, the prediction object including one or more classifications and
transmitting the one or more classifications in a prediction object to the remote computing device.

3. The method of claim 2, wherein generating the serving container includes:
retrieving a second container image that includes the second model architecture;
retrieving a model bundle that contains the trained model from the non-transient memory;
extracting the trained model from the model bundle; and
mounting the trained model to a filesystem of the second container image.

4. The method of claim 3, wherein generating the serving container further includes:
extracting a set of human-generated labels from the model bundle, each label corresponding to a different possible classification in the trained model;
configuring the model with the set of labels, whereby the one or more classifications output by the model include respective labels of the one or more classifications.

5. The method of claim 1, further comprising:
receiving a request for a serving container, the request indicating the trained model;
generating the serving container based on the trained model, the serving container including the trained model and a second model architecture that corresponds to the model architecture used to obtain the trained model.

6. The method of claim 1, wherein the container image is retrieved from a container image data store that stores a plurality of different container images, each container image include a respective model architecture that supports a different machine learning technique.

7. The method of claim 1, wherein the base model is a previously trained model and the training job updates the previously trained model with the volume of training data, wherein the volume of training data was not used to train the previously trained model.

8. The method of claim 1, wherein storing the trained model includes:
generating a model bundle based on the trained model, the model bundle including the trained model and a set of human-generated labels, each label corresponding to a different possible classification in the trained model;
compressing the model bundle into a compressed model bundle; and
storing the compressed model bundle in a model bundle data store residing on the non-transitory memory.

9. The method of claim 1, further comprising:
receiving a training request from a remote computing device, the training request indicating the type of model architecture, a reference to the volume of training data, and one or more hyper parameters;
generating a training task based on the type of model architecture and the reference to the volume of training data.

10. The method of claim 9, further comprising:
inserting the task object in a priority queue that contains a plurality of queued task objects, each queued task object indicating a respective machine learning job to be performed, a respective model architecture to perform the respective machine learning job and a respective minimum amount of computing resources required to perform the respective machine learning job.

11. The method of claim 10, wherein each queued task object further indicates a priority of the respective machine learning job, wherein the queued task objects are ordered based on the respective priority of the queued task object relative to other queued task objects and a time at which the queued task object was inserted in priority queue relative to other queued task objects having the same priority, and
wherein the task object is received from the priority queue in response to identifying the one or more available resources and when there are no higher ranked queued task objects in the priority queue that can be performed on the one or more available resources.

12. A distributed machine learning system, the system comprising:
a processing system including a plurality of processing units;
a memory system including one or more non-transitory memory devices, the non-transitory memory devices storing:
a container image data store that stores a plurality of container images, each container image including a respective model architecture of a plurality of model architectures and a default filesystem, each model architecture defining one or more machine learning software libraries;
a model data store that stores a plurality of models;
wherein the processing system is configured to execute instructions stored in the memory system to:
identify one or more available computing resources from a plurality of computing resources, the plurality of computing resources including at least one central processing unit and at least one graphical processing unit;
receive a task object that indicates a training job to perform and a type of model architecture to perform the training job;
retrieve a container image from the container image data store based on the type of model architecture;
retrieve a base model, the base model including a plurality of weights;
mount the base model to the filesystem of the container image;
retrieve a volume of training data, the volume of training data defining a plurality of events, each event including at least one instance of observation data and at least one instance of outcome data;
mount the volume of training data to the filesystem of the container image to obtain a training container;
execute the training container on at least one of the one or more available computing resources;
receive a trained model from the container after the container completes the training job; and
store the trained model in the model data store, wherein the trained model is subsequently used to generate a serving container.

13. The distributed machine learning system of claim 12, wherein the instructions include instructions to:
receive a second task object that indicates a prediction job to perform and the trained model to be used to output predictions;
generate a serving container based on the trained model, the serving container including the trained model and a second model architecture that corresponds to the model architecture used to obtain the trained model;
execute the serving container on one or more available computing resources, wherein the serving container receives input signals from a remote computing device and outputs one or more classifications based on the input signals, the trained model, and the second model architecture, the prediction object including one or more classifications; and
transmit the one or more classifications in a prediction object to the remote computing device.

14. The distributed machine learning system of claim 13, wherein the instructions to generate the serving container include instructions to:
retrieve a second container image that includes the second model architecture from the container image data store;
retrieve a model bundle that contains the trained model from the model data store;
extract the trained model from the model bundle; and
mount the trained model to a filesystem of the second container image.

15. The distributed machine learning system of claim 14, wherein the instructions to generate the serving container include instructions to:
extract a set of human-generated labels from the model bundle, each label corresponding to a different possible classification in the trained model; and
configure the model with the set of labels, whereby the one or more classifications output by the model include respective labels of the one or more classifications.

16. The distributed machine learning system of claim 12, wherein the instructions include instructions to:
receive a request for a serving container, the request indicating the trained model; and
generate the serving container based on the trained model, the serving container including the trained model and a second model architecture that corresponds to the model architecture used to obtain the trained model.

17. The distributed machine learning system of claim 12, wherein the instructions to store the trained model include instructions to:
generate a model bundle based on the trained model, the model bundle including the trained model and a set of human-generated labels, each label corresponding to a different possible classification in the trained model;
compress the model bundle into a compressed model bundle; and
store the compressed model bundle in a model bundle data store residing on the non-transitory memory.

18. The distributed machine learning system of claim 12, wherein the instructions include instructions to:
receive a training request from a remote computing device, the training request indicating the type of model architecture, a reference to the volume of training data, and one or more hyper parameters;
generate a training task based on the type of model architecture and the reference to the volume of training data.

19. The distributed machine learning system of claim 12, wherein the instructions include instructions to:
insert the task object in a priority queue that contains a plurality of queued task objects, each queued task object indicating a respective machine learning job to be performed, a respective model architecture to perform the respective machine learning job and a respective minimum amount of computing resources required to perform the respective machine learning job.

20. The distributed machine learning system of claim 19, wherein each queued task object further indicates a priority of the respective machine learning job, wherein the queued task objects are ordered based on the respective priority of the queued task object relative to other queued task objects and a time at which the queued task object was inserted in priority queue relative to other queued task objects having the same priority, and
wherein the task object is received from the priority queue in response to identifying the one or more available resources and when there are no higher ranked queued task objects in the priority queue that can be performed on the one or more available resources.
